(19) United States
(12) Patent Application Publication
(10) Pub. No.: US 2021/0272114 A1
(43) Pub. Date: Sep. 2, 2021

(54) COMPUTER SYSTEM FOR HANDLING SECURITIZED TOKEN AND VOTING CONTRACTS AND DISTRIBUTION AND VOTING TRANSACTIONS

(71) Applicant: BlockRules Ltd, Fremont, CA (US)

(72) Inventors: David Ben Kita, Fremont, CA (US); David Charles Williams, Fremont, CA (US); Pramod Madabhushi, Fremont, CA (US)

(21) Appl. No.: 17/276,811

(22) PCT Filed: Sep. 17, 2019
(86) PCT No.: PCT/US2019/051580

§ 371 Date: Mar. 16, 2021

Related U.S. Application Data
(60) Provisional application No. 62/732,532, filed on Sep. 17, 2018.
(60) Provisional application No. 62/797,011, filed on Jan. 25, 2019.

(51) Int. Cl. G06Q 20/38; G06Q 20/06; G06Q 20/36; H04L 9/32

(52) U.S. Cl. CPC G06Q 20/38215; G06Q 20/065; G06Q 20/3823; G06Q 20/3678; H04L 2209/38; G06Q 2220/00; H04L 2209/56; H04L 2209/463; H04L 9/3213

(57) ABSTRACT

Methods and systems are provided for efficient distribution of digital assets according to a token contract defined by a rule set governing token ownership, transactions, and entitlements. A token contract audit system analyzes a ledger from a token contract to determine a balance for each of a plurality of users for the contract. A token distribution contract management system generates a distribution contract and publishes the contract to a distributed blockchain system to allow a subset of the plurality of users of the token contract to interact with the distribution contract.

### FIELD OF THE INVENTION

The present disclosure generally relates to computing systems. The disclosure relates more particularly to systems for efficient distribution of digital assets and administration of voting events according to a token contract defined by a rule set governing token ownership, transactions, and entitlements.

### BACKGROUND

A distributed ledger is a ledger implemented on a network of computers, which may be geographically distributed, wherein each member computer supports one or more computational nodes each of which may execute one or more computational processes and communicate to computational nodes on any other member computer of the network using cryptographic controls in order to support and manage a distributed ledger. Henceforth in this description the term “nodes” will be used in place of “computational nodes”. The distributed ledger contains records of processed blockchain transactions and is distributed in such a manner that copies of all or part of the ledger can exist at various nodes in the computer network. The blockchain transactions might be grouped sequentially into collections called blocks. For ease of computationally verifying that a given copy of the distributed ledger is authentic, the distributed ledger might be stored as a blockchain, wherein validation of one block of the blockchain (within a statistically probable certainty) can occur only if all of the earlier blocks are valid and are unaltered from their original form existing at the time those blocks were added to the blockchain. In this blockchain scheme, users may use one or more nodes to post blockchain transactions containing references to transfers of value or information and once those blockchain transactions are grouped into a block and that block is accepted onto the blockchain, the blockchain transactions would become permanently recorded in that nodes would not accept altered blocks to replace the original blocks that were previously added to the blockchain. The programming of the nodes may be such that one node would not accept a blockchain transaction or block from another node if that blockchain transaction or block appeared to be altered from the original. Alteration could be detected if each blockchain transaction and/or block were secured using a cryptographic protocol that would make it statistically impossible for a party to make an alteration and still have the blockchain transaction and/or block validate when it is cryptographically checked.

A blockchain can be represented in computer memory as a cryptographically-linked, ordered list of blocks and need not be bounded. Each block might contain blockchain transaction data about one or more blockchain transactions, a cryptographic hash of a previous block, and other metadata, such as a blockchain transaction timestamp. Generally a blockchain uses a cryptographic hash that is both deterministic, in that for any given block or set of blocks, there is one valid hash value that can be easily verified, and irreversible, in that it is not possible to fabricate an original block that matches a specific hash value without expending an impractical amount of computational resources.

Since the hash serves as a fingerprint of sorts for a block, and since any alteration of the block would result in a different hash, if the hash of a block is included in the data that is hashed in a later block, a node can easily check whether any of the blocks in a blockchain have been altered. As a result, a blockchain is resistant to data modification since the precise contents in any block can be verified at any time against the cryptographic hash contained in the subsequent block, such that a block cannot be retroactively changed without altering all subsequent blocks.

A distributed blockchain can be implemented on multiple nodes, wherein a node might be an instance of blockchain processing code executed on a computer and able to communicate with other nodes. The nodes may be geographically separated. In a typical implementation, each instance maintains a copy of the blockchain. Instances might communicate through a peer-to-peer network in order to maintain the integrity of the blockchain and obtain updates, such as new blockchain transactions or new blocks. In some cases, a consensus scheme might be used in advance to decide which version of the blockchain is authoritative in case of any discrepancy. Such consensus schemes are typically designed to favor the longest or most popular version of the blockchain. After validation, each node might operate under the assumption that its copy of the blockchain is the authoritative version without having to constantly run verification. In this manner, operations applied to one instance would be considered authoritative if queried by any other instance as long as that operation is encoded on a validated copy of the blockchain. A public distributed blockchain (PDB) is a distributed blockchain supported collaboratively by the general public, in that almost any interested party can install and operate a node on their computing equipment and connect their node to other nodes on the blockchain network. Since an interested party can join such a public distributed blockchain network at will, such a blockchain is considered publicly available and publicly accessible. Although a central authority might be needed to establish a set of rules under which the PDB operates (and perhaps provide the computer code needed for implementation), once launched, control of the PDB can be passed to a (presumably large) community of public users who set up nodes and follow the established rules. A properly implemented PDB that enjoys sizable and worldwide participation is practically impervious, as a whole, to unauthorized manipulation by any one party.

Before a node adds a block to the blockchain, the node should verify the blockchain transactions that are grouped into the block. In some distributed blockchain systems, the process of creating a block might include a requirement that the node perform some nontrivial computational process so that it is difficult for a node to freely generate possibly bogus blocks to add to the blockchain. The nontrivial computational process might involve a cryptographic or mathematical problem that is difficult to solve but where it is relatively easy to verify that a proffered solution is indeed a correct solution. As part of block generation, besides solving associated cryptographic or mathematical problems, the node will process all blockchain transactions that are to be grouped into the block to ensure that each blockchain transaction is valid.

### SUMMARY

A computer-implemented system for efficient distribution of digital assets according to a token contract in accordance with a rule set governing token ownership, transactions, and entitlements might comprise a token contract audit system, coupled to a blockchain ledger associated with the token contract, that examines the blockchain ledger to generate a token holdings list that comprises holder addresses of users and corresponding token balances as of a provided date of record or other predetermined point in time, and an interaction event contract management system that communicates with the token contract audit system and generates, publishes, and administers interaction event contracts on the BVM of the blockchain system, that for each interaction event comprises at least one interaction event contract and contract allowance instructions, wherein the interaction event contract management system generates the contract allowance instructions according to the token holdings list received from the token contract audit system, and wherein the—interaction event contract management system allows users to communicate with the distribution contract to fulfill the obligations of the interaction event according to the contract allowance instructions.

The computer-implemented system might comprise a token contract registration system that is configured to receive and store user registration information from users in association with holder addresses of users. The token contract audit system might be configured to communicate with the token contract registration system to retrieve interaction event eligibility criteria associated with holder addresses for inclusion on the list of participating token holders. The token contract audit system might be configured to communicate with the token contract registration system to retrieve additional eligibility criteria associated with holder addresses, wherein the additional eligibility criteria instruct the token contract audit system to exclude associated holder addresses from the list of participants.

The interaction event contract might be applied, in total or in part, to multiple interaction events for one or more separate security tokens. The contract allowance instructions might enable users on the token holdings list to communicate with the interaction event contract using a validated holder address. The contract allowance instructions might enable users on the token holdings list to communicate with the interaction event contract using a preferred holder address.

The interaction event contract may represent a distribution, in which case the interaction event contract could perform blockchain operations that permit the distribution of a type of asset that is represented on the BVM, such as a payment token that can act as a fixed value of some amount of currency, to a set of eligible holders. In other examples, the interaction event contract may represent a vote, in which case the interaction event contract could perform operations that permit eligible token holders to express their preference among a set of options associated with the vote.

In some aspects, a token contract audit system examines a blockchain's state at a given past time and derives a token holdings list representing those holder addresses that controlled tokens at that given past time (the date/time of record perhaps) and other information about those holdings. Other information might include number of tokens and specific eligibility requirements derived from holder registration data that might be used to signal qualifications. It may be that some eligibility requirements would indicate that, under some conditions, a token holding cannot participate in the interaction event. The conditions might be variable in that a holder gets to participate, but only after other requirements are met. As an example, the condition might be that a holder belongs to or does not belong to a certain class. These details and the token holdings list can be encoded into an interaction event contract.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 illustrates a block diagram of a system for efficient distribution of digital assets according to a token contract defined by a rule set governing token ownership, transactions, and entitlements.

FIG. 2 illustrates a method for distributing digital assets associated with a security tokens in a token contract implemented on a BVM of a blockchain system.

FIG. 3 illustrates a block diagram of a system for collecting and recording voting events on a blockchain system according to a token contract defined by a rule set governing token ownership, transactions, and entitlements.

FIG. 4 illustrates a method for collecting and managing voting events consistent with constraints imposed by a voting contract implemented on a BVM of a blockchain system.

FIG. 5 illustrates a computer system that can be employed to implement examples of the systems and methods disclosed in FIGS. 1-4.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details.

Furthermore, well-known features may be omitted or simplified in order not to obscure the embodiment being described.

The systems and method provided herein may include a distribution system that is decentralized, transparent, and compliant with a defined rule set through the use of a blockchain infrastructure. For example, an issuing party can stipulate the defined rule set in order to enforce laws or regulations governing the ownership or trading of securities or other transactions between parties on a smart contract, such as a token contract. The defined rule set can also be used to enforce other obligations or requirements between the issuer of the token and token holders, or between token holders. For example, the tokens being sold by an issuing party for a token contract can have specific limitations regarding who (or what receiving party or entity) may initially purchase them, or separate limitations regarding secondary trading, especially if they correspond to a regulated security or other assets with contractual obligations. It will be appreciated that a token holder is an entity controlling one or more holder addresses and either owns, or is interested in purchasing or acquiring, one or more tokens associated with the token contract. As part of a defined rule set constructed by an issuing party, token holders may have rights related to distribution of dividends, royalties, or other funds earned from security tokens. As part of a defined rule set constructed by an issuing party, token holders may have rights related to voting earned from security tokens. In a typical scenario, the issuing party would announce a date of record for a distribution or voting event in advance.

A blockchain virtual machine (BVM) can be considered a computing environment that is encoded as blockchain transaction data on a distributed blockchain. A BVM may be considered a Turing-complete state machine, including a plurality of smart contracts, each of which are composed of sets of computer instructions and/or preserved data that is stored on the blockchain and accessible to the smart contract. A BVM environment uses the creation of validated blocks as a method for maintaining a self-consistent, singular global state of the BVM across all nodes running the BVM. Furthermore, because a BVM is implemented on a blockchain system, the execution of each computer instruction can be cryptographically verified. In addition, since a BVM is implemented on a distributed blockchain, instruction execution is secure, transparent, and decentralized. Unlike a traditional distributed blockchain, which may need to be rewritten and redeployed for each new application, a single BVM can support a number of independent applications that can be deployed at any date after the BVM is initiated and that are executable on the BVM.

Each such application is written in computer code such that it can be introduced and executed on the computing environment provided by the BVM. It is often useful to consider the BVM as a general-purpose computing platform that is decentralized, transparent, and verifiable, but it should be understood that it is often implemented on computing nodes in a distributed computing system performing computations that perform the operations of the BVM.

In order to perform its functions, each application on a BVM responds to messages that originate outside the BVM, for example from a node that is passing on input obtained from a human user, either representing themselves or an organization, or from another computer executing preassigned instructions, such as a conventional computer service. Each message might be encoded with an address that corresponds to a unique identity of the source of the message. Some messages are cryptographically signed to ensure that the address cannot be forged. This is generally achieved by utilizing a cryptographic method such that a message can be readily and correctly signed by someone with knowledge of a secret key, password or passphrase(s), such that the message signature is easily verified by others, and such that the message cannot be correctly signed by someone without providing the secret key, password or passphrase(s). Thus, an application implemented on a BVM can use the address of the signed messages it receives to verify the identity of its users. In some BVMs, messages that cause, or could potentially cause, the state of the BVM to change must be incorporated into the blockchain ledger in order for the state and the blockchain ledger to remain consistent. Such messages may be considered to be blockchain transactions, even though the message is not necessarily associated with the transfer of any value are might not be considered a financial transaction in the conventional sense.

As mentioned herein, smart contracts, which can each be identified by a unique address on the BVM, can be implemented by, and represented by, ordered sets of machine-readable instructions associated with data stored on the blockchain and accessible to the smart contracts. These smart contracts, whether enacted on their own or working together with one another, can be used to perform one or more operations on the blockchain, including the enforcement of certain provisions as stipulated by set of rules, including, for example, the terms of a non-digital contract. As such, smart contracts can in principle be used to effectively control the ownership or transfer between parties of digital currencies or assets, including security tokens issued by an issuing party. In other blockchain environments, the smart contract may be embedded in the virtual machine environment through special blockchain transactions. After embedding the smart contract in the virtual machine environment, nodes operating as part of the blockchain network can evaluate blockchain transactions which reference the smart contract or directly invoke a portion of the smart contract in the form of one or more code functions calls. The smart contract processing might take in digital information as input, digitally process the information according to the rules of the smart contract, and digitally execute any actions as required by the terms and conditions of the smart contract.

Smart contracts can be implemented on a BVM of a blockchain system and can be executed at a node of a BVM as a collection of executable code and stored data in order to digitally enforce the provisions of an associated set of rules, including, for example, terms of a non-digital contract, provided the necessary digital information is available to the system executing the instructions of the smart contract. As an example, smart contracts can be used to determine whether an asset should go to a person (receiver) or should be returned to the person from whom the asset originated (sender).

Messages may be sent by one smart contract to another, in which case the message is associated with the address of the smart contract that initiated the message. In this fashion, users or processes outside the BVM may send blockchain transactions to an intermediate smart contract that then performs further blockchain transactions on their behalf by sending additional messages. When the intermediate contract is under the exclusive control of one party, any blockchain transactions that originate at the address of the intermediate contact are identified with the party that controls it.

A token might be a voucher implemented in a BVM that represents something of value, such as goods or services or future revenue, currency, or a unit of exchange. A specific class of token is typically implemented in an associated BVM application as a blockchain ledger that assigns a numerical quantity to individual addresses representing a current quantity of the thing of value represented by the tokens allocated to each address. Such tokens may then be transferred from one address to another by the BVM performing computational operations and recording the associated changes of state on the blockchain ledger. The rules for how such tokens are created, disposed of, assigned, and traded are embedded in the implementation of the associated BVM application, and as such, have the same characteristics of transparency and verifiability that are associated with the BVM as a whole. Tokens may represent securities interests, such as, but not limited to, shares of equity, units of debt, or contractual rights to a dividend or royalty. In such cases these tokens are referred to as “securitized tokens” or “security tokens.”

Token contracts are a type of smart contract that can record and perform actions with already existing tokens, generate or issue new tokens, and execute various transactions involving tokens. The individual or organization that is responsible for issuing the securities associated with a token is referred to as the token issuer. The issuer is generally responsible for publicly identifying the address of the token contract associated with the issued security and would be involved, directly or indirectly through a third party, with the implementation of the token contract. An individual or organization that has a nonzero balance of tokens is referred to as a token holder. A token holder would normally associate their holdings with one or more addresses under their control. An address under the exclusive control of a current or potential token holder (or potential holder for short) will be referred to as a “holder address”. A holder address is therefore associated with a single and specific current or potential token holder, whether it be an individual or organization.

The Ethereum Network is a BVM that runs smart contracts. ERC-20 is a technical standard sometimes used as part of token contracts implemented on the Ethereum Network. ERC-20 defines a common list of rules for tokens to follow to enable compatibility with third-party services and applications. These rules include how the tokens are transferred between addresses and how the ledger for each token is accessed. Variants of the ERC-20 are in use on other implementations of a BVM such as HyperLedger. Since the ERC-20 standard relies on generic features of a BVM, it is expected that the ERC-20 standard or a functionally equivalent standard is or will be available on many current BVMs and will be available on many future BVMs.

In an implementation specific to the Ethereum Network and related BVMs, each smart contract written on the BVM can provide public methods, and the BVM identifies a method call by using a hash of the method signature. The ERC-20 token standard requires implementation of the methods shown in Table 1.

TABLE 1

| Method Structure | Method Return Value | Uses of Method |
|---|---|---|
| totalSupply ( ) public view | uint256 total Supply | Getting the total token supply |
| balanceOf (address_owner) | uint256 balance | Getting the account balance of |
| public view | | another account having the |
| | | address_owner |
| transfer (address_to, | bool success | Sending_value amount of tokens |
| uint256_value) public | | to the address_to |
| transferFrom (address_from, | bool success | Sending_value amount of tokens |
| address_to, uint256_value) public | | from address_from to address_to |
| approve (address spender, | bool success | Approving a withdrawal by_spender |
| uint256_value) public | | from an account associated with a |
| | | holder address that grants approval, |
| | | multiple times, up to the_value |
| | | amount. If this function is called |
| | | again, it overwrites the current |
| | | allowance with_value. |
| allowance (address_owner, | uint256 remaining | Returns the amount which_ |
| address_spender) public view | | spender is still allowed to |
| | | withdraw from_owner |

In other environments, similar or different methods might apply.

There can be many reasons that an issuer of a security, or some other authority, may need to interact with the holders of the security. For example, an issuer may need to conduct a distribution, which is a payment of assets to all or many security holders. In another example, certain actions of an issuer may only be performed if formally approved by some or all of the security holders. In another example, an issuer or some other authority may wish to send some type of collateral, like an annual report, to all or some of the security holders. The process of interacting with all or some security holders for a specific purpose will be referred to as an interaction event. It should be understood that typically interaction events generally occur within a specific and predetermined time frame.

A distribution is one form of interaction event. Each recipient of a distribution is referred to as a beneficiary. The entity that is providing the payment, typically the issuer of the security, is referred to as the payor. The size of the payment is usually in proportion to the amount of security held by the beneficiary. The assets used for payment may be an allocation of the associated security, an allocation in the form of one or more securities, cash, or some other object of value. The distribution may represent the allocation of dividend or interest income generated by a fund, profit sharing in the form of a fixed portion of the income or profit of the issuer, payment to holders of an IRA or other retirement account, a result of a sale conducted over a period of time, or the result of some other type of financial transaction or obligation. The distribution may be one of many that occur at a fixed schedule, may be one of many that occur at irregular points of time, or may be a onetime event.

To execute a distribution, the payor identifies the list of eligible security holders and the corresponding size of their holdings and uses some form of payment transfer. For conventional securities, payment is typically by deposit to an account, in which case current account information for each security holder is required, or by check send by mail or courier, in which case a current address for each security holder is required, or by some combination thereof. If the security is held for a security holder by a third party (a custodian, for example, a broker, bank or other type of financial institution), it may be the responsibility of this third party to relay payment to the holder. In the case of a third parties, it may be necessary for payment to be relayed by multiple intermediaries. Since a distribution requires the collection of a variety of data for different sources (current holder amounts, current bank account numbers, current physical addresses) and may require an accurate execution of tasks from multiple intermediaries or other third parties, even with the support of electronic ledgers, computer systems and electronic banking, it can be a time consuming, expensive, and unreliable process.

A vote is another form of interaction event. Holders of a security may have the right to vote on certain matters, including matters that affect security ownership, such as a stock split, proposed merger, or proposed acquisition, matters associated with executive compensation, or matters associated with corporate governance. For conventional securities, such as stocks, voting rights might be exercised in formalized events such as annual general meetings or a special meeting, for which all holders receive formal invitations. Sometimes each holder has a vote in proportion to the size of the holder's holding. Sometimes each holder may have one vote, regardless of the size of the holder's holding. There may be some security holders who are not permitted to vote on certain matters, perhaps due to a conflict of interest.

To execute a vote, the relevant authority identifies the list of eligible security holders, referred hereafter as the voter list, and, if applicable, the corresponding size of their holdings. For conventional securities, votes may be by formal invitation, in which case contact information such as a current address for each security holder is required, or by paper ballot, in which case, again, contact information such as current physical address for each security holder is required, or by some combinations thereof. If the security is held for a security holder by a third party (a custodian, for example, a broker, bank or other type of financial institution), it may be the responsibility of this third party to vote in place of the holder or forward a proxy form to the holder in which to record a vote. In the case of a third parties, it may be necessary for the vote to be relayed by multiple intermediaries. Since a voting system requires the collection of a variety of data for different sources (current holder amounts, contact information, current physical addresses) and may require an accurate execution of tasks from multiple intermediaries or third parties, even with the support of electronic ledgers and computer systems, it can be a time consuming, expensive, and unreliable process.

Current implementations of token contracts on BVMs that are associated with rights to receive distributions from the token issuer or conduct votes generally lack robust and efficient mechanisms for delivering distributions to token holders or allowing them to vote.

An issuer of a token could maintain a list of, and contact info for, all token holders. However, this could be cumbersome and potentially insecure and/or inaccurate, especially if tokens are eligible to trade. A distribution system (or voting system) that is performed on a blockchain is greatly preferable in order to provide both security and transparency. In case of distributions, current implementations may be capable of delivering payouts to holders as a collection of transfers of tokens invoked by the payor, but these approaches do not allow for distributions to a list of token holders as of a date of record rather than the current holding list when the distribution is started. In case of voting, current implementations may be capable of delivering voting rights to holders, but these approaches do not allow setting voting eligibility to a list of token holders as of a date of record rather than the current holding list when the voting is started. Current implementations also fail to enforce directly the transaction of distributions (or voting) on a blockchain system according to a date of record and a defined rule set governing token ownership, transactions, and entitlements. It will also be appreciated that current implementations of BVMs typically require payment for their use, with the amount of payment increasing with the amount of computer processing required to perform a transaction, or with the amount of data required to be stored in the token contract.

Accordingly, there is a need for an interaction event system and methods that allow for efficient and automated distribution on a blockchain system of dividends, royalties, or other funds earned from the security tokens, based on the state of all token holdings for a token contract on the distributed ledger as of the date of record, wherein the date of record might be a specific time on a specific date, and enforcing restrictions and conditions associated with distribution of security tokens in an efficient manner. To this end, systems and methods are disclosed for a token contract registration system that collects relevant information from registered users, for a token contract audit system that examines the token contract in order to create a list of token holdings as of a date of record and for an interaction event system such as a token distribution contract management system that generates, publishes and administers an additional smart contract that is made available on the blockchain for token holders who are eligible to receive a distribution of dividends, royalties, or other funds earned from security tokens, so that they can claim their distributions in an efficient, convenient, and secure manner. In one example, the generated additional smart contract is a distribution contract that could be used for profit sharing, which could be part of an agreement between a party issuing security tokens and token holders. In one embodiment, if there are a series of distributions, then for each distribution, the token distribution contract management system generates and deploys a new distribution contract at an appropriate time based on the contents of the token contract at that date of record.

In another embodiment, an interaction event system can be employed for efficiently collecting and recording voting events on a blockchain system. During a voting event, votes can be allocated to holders of a security token in accordance to the state of all security token holdings for a token contract on the distributed ledger as of the date of record, wherein the date of record might be a specific time on a specific date. The compliance contract management system enforces restrictions and conditions that are specified in token contract that are stored on the blockchain. A token contract might include provisions that are restrictions and conditions about a voting process. Thus, the compliance contract management system can enforce restrictions and conditions on voting and allocating votes in a voting process.

Additional systems and methods with regards to an interaction event system used for managing voting systems are disclosed for a token contract registration system that collects relevant information from registered users, for a token contract audit system that examines the token contract in order to create a list of token holdings as of a date of record and for a voting contract management system that generates, publishes and administers an additional smart contract that is made available on the blockchain for token holders who are eligible to receive an allocations of votes as determined by their holding of security tokens, so that they can vote in an efficient, convenient, and secure manner. In one embodiment, the allocation of votes is determined by the holdings of registered user for a particular security token. In another embodiment, the allocation of votes is determined by the combined holdings of registered users across a plurality of security tokens, presumably, though not necessarily, associated with different token contracts. In one example, the generated additional smart contract is a voting contract that includes program code defining each user's vote weight, which might be represented by a numerical value associated with the user's vote as well as possible ballot options and selections from among those ballot options. In these embodiments, users can call a method or function associated with the voting contract to add some or all of their vote weight to a chosen ballot option's score, which might be represented by a sum of all vote weights for a given ballot option.

In another embodiment, vote allocations can be represented as voting tokens, and security token holders receive different quantities of voting tokens according to their security token holdings as determined by the token contract audit system and encoded in the voting contract by the voting contract management system. In these embodiments, the voting contract is treated as both a distributer of voting tokens and as a ballot. A voting contract system can comprise a voting contract that includes the sum of all users' voting tokens and one or more “option addresses” each with a unique address into which users can choose to transfer one or more of their voting tokens. This act of transferring a voting token from an address controlled by a user having a right to vote that voting token and to an address controlled by a vote tabulator is, in effect, the casting of a vote. Herein, this act might be referred to as a “voting event.” In one embodiment, if there are a series of voting events related to a token contract, then for each voting event, the voting contract management system generates and deploys a new voting contract system at an appropriate time based on the contents of the token contract at that date of record. In another embodiment, all votes can be transferred to only one option address. For example, a voting contract system is setup for board of directors' position with three candidates Alice, Bob and Carol. Each of the candidates is setup with a unique option address. In one embodiment voting tokens can distributed arbitrarily to different candidates (option addresses), and in another embodiment, all tokens can be sent to only one candidate (option address).

As described herein, details of a smart contract or token contract might be described as the contract taking some action via a BVM on the distributed ledger of the blockchain system. It should be understood that in an implemented blockchain system, there might be nodes of a computing system that process the instructions or elements of the contract to determine whether or not to take an action. With properly programmed nodes, or a consensus among nodes to operate in a certain way (and exclude nodes that do not operate in that way), as the nodes are conforming to the details of a contract and performing a consistent action, for readability, this might be referred to as the contract taking that action.

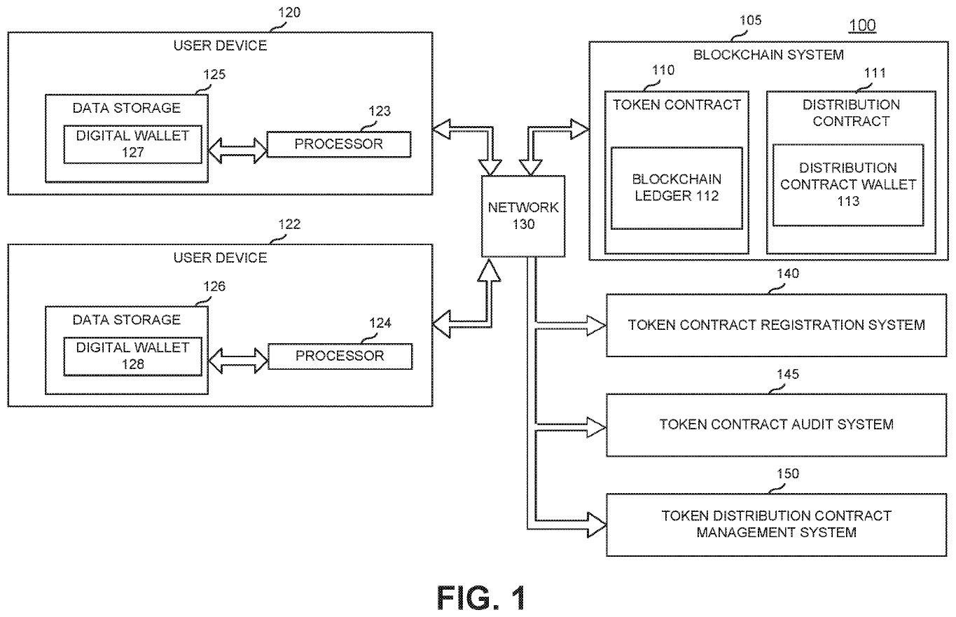

FIG. 1 shows a block diagram of a system 100 for efficient and automated distribution of dividends, royalties, or other funds earned from the security tokens on a blockchain. The system 100 includes a blockchain system 105, which may be a BVM, implementing a token contract 110 that includes a blockchain ledger 112, a plurality of user computing devices 120 and 122, a token contract registration system 140 that interacts with each of the plurality of user computing devices 120 and 122 and the blockchain system 105 via a network 130 (e.g., the Internet or an intranet), a token contract audit system 145 that interacts with the token contract 110 via a network 130, a token distribution contract management system 150, which interacts with the token contract 110, token contract registration system 140, and token contract audit system 145. The token distribution contract management system 150, which might be an interaction event contract management system dedicated to distribution events, generates, publishes, and administers a distribution contract 111 that includes a distribution contract wallet 113 and runs on the blockchain system 105. It will be appreciated that in various embodiments the token contract registration system 140, the token contract audit system 145, and the token distribution contract management system 150 communicate in various combinations with each other, the user devices 120 and 122, and the blockchain system 105 with its contracts and components via a network 130. The user computing devices 120 and 122 can interact with the distribution contract 111 via the network 130 in certain embodiments.

Each of the plurality of user computing devices includes respective hardware processors 123 and 124 operatively connected to electronic data storage 125 and 126, such as volatile or non-volatile memory. In the illustrated example, the electronic data storage 125 and 126 at each of the plurality of user computing devices 120 and 122 stores a digital wallet 127 and 128. A digital wallet 127 and 128 can be a data structure used to store associated data on common or dedicated electronic data storage (e.g., RAM, or a hard-drive). In certain examples, dedicated hardware devices, such as a hardware security module (HSM), may be used to store information associated with the digital wallets 127 and 128. In certain example embodiments, the digital wallet 127 and 128 may be stored on a dedicated storage hardware that is implemented externally and in communication with the system 100 for at least a time necessary to complete a transaction (e.g., via a communication link or local bus connection).

Each digital wallet 127 and 128 can be implemented as software instructions executed by a hardware processor, or specifically designed hardware, that stores information that allows an individual to make electronic commerce transactions that use, for example, a blockchain. Each digital wallet 127 and 128 can include or store a data structure that holds a private key and one or more BVM addresses that are a product of the private key. Other users can utilize these identifiers to send transactions to the BVM associated with a stored address, which can then be used to perform authorized actions on the blockchain. In some systems, authority for such transactions can be conveyed by signing messages with a digital signature generated from the private key corresponding to the appropriate holder address. In certain exemplary embodiments, each digital wallet 127 and 128 may only be capable of sending blockchain transactions to the BVM with a stored address after users provide a private key or other identifier by direct manual input, for example, from a keyboard, by spoken instructions, or using a device that identifies a specific biometric marker.

A digital wallet can be implemented as a logical container for tokens and/or spendable assets that are represented on a blockchain such that the blockchain nodes would accept a transaction from a wallet address of that wallet if the transaction validly indicates authority of the wallet owner. Such authority might be conveyed by showing possession of private keys or credentials, such that the person or entity knowing those credentials can spend those tokens. In some systems, authority can be conveyed by signing digital messages with a digital signature generated from the private key corresponding to the appropriate wallet address.

Multiple computer nodes implement the token contract 110, and each node operates to validate blockchain transactions submitted to the token contract. Generally, only one of the nodes needs to receive a blockchain transaction that an address on the blockchain system 105, whether the address is an external address or a smart contract running on the BVM and controlled by an external address, has submitted for the blockchain transaction process to continue. Once an instance of the token contract 110 at one node receives a blockchain transaction, it may propagate the blockchain transaction to other nodes within the blockchain system 105. Each node that is part of the blockchain system 105 may also keep a copy or a portion of the blockchain in memory that is local to the corresponding node.

As shown in FIG. 1, embodiments of the systems and methods provided herein provide tools for registration, such as a token contract registration system 140, to collect relevant registration information from registered users, who may be current token holders or are interested in purchasing or acquiring tokens. Registration information could include, but is not limited to, a name, physical address, contact information, country of citizenship and country of residence for individuals, and countries where the registering user meets requirements for being accredited or qualified. Registered users may also be organization, in which case the registration information could include, but is not limited to, name of organization, company address, contact information, name of signatory authority, country of organization or incorporation, country/countries of business operation, and the status of certain business licenses if applicable.

Registration information may also include registration of a preferred payment address, which is an address that a registered user indicates as the desired destination for any entitled distributions. The issuing party or the token contract registration system 140 can collect registration information for a given token holder, as necessary, before the initiation of any distribution. In some embodiments, the token contract registration system 140 reviews the registration information in order to verify its authenticity, such as whether a provided mailing address is a legitimate address, or that passes various KYC/AML verification requirements. When the token contract registration system 140 finds the registration information for a given user to be verified, it stores that registration information indexed to that user's one or more holder addresses herein referred to as a “validated holder address.” In other embodiments, another party, such as human agents, perform all or a part of the verification process and report their determination to the token contract registration system 140. In some embodiments, a registered user may have more than one associated holder address. In one embodiment, the token contract registration system 140 preferred payment address for a registered user may be stored by the token contract registration system 140 on the token contract 110 with each corresponding validated address associated with the registered user. In another embodiment, the token contract registration system 140 instead transmits the preferred payment address to the token distribution contract management system 150 for storage on a newly generated distribution contract 111. In another embodiment, the registered user is allowed to update their preferred payment address after the date of record, but before the initiation of distribution, and the change in their preferred payment method is communicated to the token distribution contract management system 150 for incorporation into the additionally generated token distribution contract 111. In another embodiment, additional distribution eligibility criteria for each validated holder address of a registered user, wherein the distribution eligibility criteria are determined according to a defined rule set governing distribution from the token contract 110 for a distribution event, are also stored on the token contract 110 by the registration system. The additional eligibility criteria can include, for example, an expiration date for the user's registration information, a lock status variable that can be used to indicate that a registered user is prohibited from receiving a distribution, or a variable that indicates if the validated holder address is owned by the issuer of the token or an individual otherwise affiliated with the issuer of the token.

As shown in FIG. 1, embodiments of the systems and methods provided herein provide tools also for auditing of the token contract, such as a token contract audit system 145, to conduct an audit of the token contract as of a specified date, typically a date of record, by monitoring or examining from the ledger 112 of token holdings on the token contract 110. In monitoring or examining the ledger 112 of the token contract 110 in its entirety, the token contract audit system 145 produces a digital token holdings list of all validated holder addresses with non-zero token balances as of the date of record. In one embodiment, if the preferred payment address for a registered user who owns or controls a validated holder address is also stored on the token contract 110 along with the validated holder address and the token balance, then the token contract audit system 145 can also embed the preferred payment address for each validated holder address with non-zero balance into the generated token holdings list that the token contract audit system 145 sends to the token distribution contract management system 150.

In one embodiment, the token contract audit system 145 will review the token contract by reviewing blocks on the blockchain from the inception date of the token contract 110 up until the last block added to the blockchain ledger 112 with a timestamp before the date of record. In another embodiment, the token contract audit system 145 also considers additional eligibility criteria for a registered user stored on the token contract 110 to determine if the registered user's holder addresses and balances should be placed into the digital token holdings list.

In one example, if the expiration date of registration information for the registered user has expired then the token contract audit system 145 does not write the validated holder address and associated token balance into the digital token holdings list. In another example, if the expiration date of registration information for the registered user has expired, then the token contract audit system 145 writes the validated holder address and associated token balance into the digital token holdings list but with an attendant bit flag reflecting expiration. In another example, if the lock status variable is set to true, indicating that the validated holder address is locked and unable to participate in blockchain transactions, then then the token contract audit system 145 does not write the validated holder address and associated token balance into the digital token holdings list.

In yet another embodiment, if the lock status variable is set to true, indicating that the validated holder address is locked and unable to participate in blockchain transactions, then then the token contract audit system 145 writes the validated holder address and associated token balance into the digital token holdings list but with an attendant Boolean flag reflecting that the registered user's holder address is locked. In another example, if the validated holder address is owned by the issuer of the token or an individual otherwise affiliated with the issuer of the token then the token contract audit system 145 does not write such a validated holder address and associated token balance into the digital token holdings list. In yet another embodiment, if the validated holder address is owned by the issuer of the token or an individual otherwise affiliated with the issuer of the token then the token contract audit system 145 writes such a validated holder address and associated token balance into the digital token holdings list, but with an attendant set of bits reflecting that the registered user's holder address is owned by the issuing company or by an individual otherwise affiliated with the issuer of the token.

As shown in FIG. 1, embodiments of the systems and methods provided herein also provide tools for a token distribution contract management system 150 that generates, publishes, and administers an additional smart contract, referred to as a distribution contract 111, which is made available on the blockchain system 105 for token holders who are eligible to receive a distribution of dividends, royalties, or other funds earned from security tokens so that they can claim their distributions in an efficient, convenient, and secure manner. Criteria used to determine eligibility might comprise user status, user constraints, tax domicile, citizenship, residency, or other user detail on the date of record.

In one example, the generated additional smart contract may be used for profit sharing, which could be part of an agreement between a party issuing security tokens and token holders. In another embodiment, a new distribution contract 111 is created after the date of record based on the contents of the distribution token holding list of produced by the token contract audit system 145. When constructed, this new distribution contract 111 contains at least one distribution contract wallet 113 with a corresponding address that is administered by the token distribution contract management system 150. An issuing party then fills the distribution contract wallet with an appropriate cryptocurrency, referred to herein as distribution coins or coins for short, such as a stable coin token, which is a currency token that is convertible to a specific amount of fiat currency, for distribution according to the token holdings list. The token distribution contract management system 150 assigns an appropriate third-party allowance to each registered user's holder address that is included on the distribution token holdings list provided by the token contract audit system 145, so that each registered user can transfer their allotment of distribution coins for each of their holder addresses to their preferred payment address from the distribution contract wallet 113 at each user's discretion at a time and in a manner of each user's choosing.

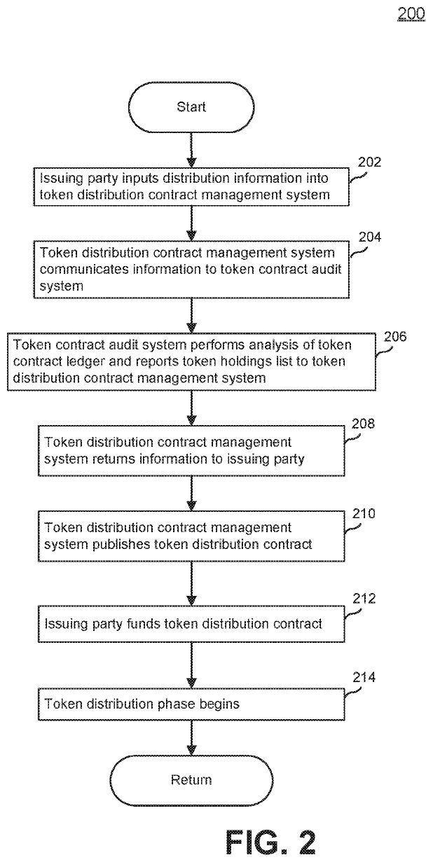

In view of the foregoing structural and functional features described above, example methods will be better appreciated with reference to FIG. 2. While, for purposes of simplicity of explanation, the example methods of FIG. 2 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The methods may be implemented by the system 100 of FIG. 1.

FIG. 2 describes a method of distributing a payment to token holders according to an embodiment, with reference to system 100 of FIG. 1. At step 202, an issuing party, a party or entity who is the issuer of the tokens of the token contract 110, that has obligations to token holders to make a distribution payment, or otherwise elects to do so, initiates the distribution by informing the token distribution contract management system 150. The issuing party may do so through the use of an API, although the invention is not so limited. The issuing party instructs the token distribution contract management system 150 of the details of the required distribution. These details, herein referred to as distribution information, include, for example, the date of record of the distribution. These details may also include, for example, the structure of the distribution according to a defined rule set governing distributions for the token contract, such as the amount or percentage of the distribution that each token holder is entitled to receive, and the total amount of the distribution or the total amount from which the distribution shall be calculated. For example, the issuing party may inform the token distribution contract management system 150 that each token holder is entitled to a fixed amount, as in a distribution of interest on debt. In another example, the issuing party may inform the token distribution contract management system 150 that each token holder is entitled to a pro rata portion of a payment, as in a distribution of a dividend. In another example, the issuing party may inform the token distribution contract management system 150 that each token holder is entitled to a fixed percentage of an amount of money earned by the issuer, as in a distribution of a portion of the issuing company's revenues.

Continuing with reference to FIG. 2 and system 100 of FIG. 1, at step 204, the token distribution contract management system 150 initiates a token contract audit 145 by informing the token contract audit system 145 of at least a portion of the distribution information. In some embodiments, the token distribution contract management system 150 informs the token contract audit system 145 of the date of record. In other embodiments, the token distribution contract management system 150 further informs the token contract audit system 145 of other information relevant to the audit, such as any offsets in the date of record for certain types of token holders or token blockchain transactions.

Continuing with reference to FIG. 2 and system 100 of FIG. 1, at step 206, the token contract audit system 145 performs an analysis of the token contract ledger 112 so as to generate a token holdings list comprising distribution data wherein the distribution data includes holder addresses of token holders as of the date of record who are to receive a portion of the distribution, the amount of tokens held by each of the token holders' holder addresses on the token contract 110, and if applicable the preferred payment addresses of each token holder. In one embodiment, the token contract audit system 145 only stores distribution data on the token holdings list for a holder address of a token holder, if the corresponding balance of tokens on the token contract 110 was non-zero for the holder address as of the date of record. In one embodiment, the token contract audit system 145 stores the token holding list as a key/value mapping between the holder address and the other distribution data, although other data structures are possible. In another embodiment, the token contract audit system 145 stores the token holding list as a key/value mapping as part of an additional audit token contract, published by the token distribution contract management system 150, on the blockchain system 105. In other embodiments, the token contract audit system 145 stores the token holding list outside of the blockchain 105 in a database for later querying by the token distribution contract management system 150.

It will be appreciated that in certain BVMs, determining the balances of token holders as of a prior date may not be possible simply by calling a method of the token contract 110 or examining the current state of the token contract 110. In some embodiments, the token contract audit system 145 may instead re-create the token contract ledger 112 as of a record date by examining the blockchain ledger 112 block-by-block, starting from the first block at the inception of the token contract 110, tracking both the initial balances of newly registered holder addresses and any transfers of tokens between the holder addresses of token holders, and maintaining a temporary state of token holdings that is updated with each tracked blockchain transaction. This examination halts with the final block that was written to the blockchain 112 with a timestamp closest to but before the date of record, although examination may continue to account for offsets in the date of record for certain types of token holders or token blockchain transactions. In one embodiment, once the token contract audit system 145 completes the examination, the token contract audit system 145 records the latest state of token holdings representing token ownership as of the date of record across all holder addresses on the token contract. The token contract audit system 145 then evaluates this latest state of token holdings in order to populate the token holdings list with the relevant distribution data. Alternatively, the token contract audit system 145 may read the event log of the blockchain system 105, if one exists, to track the transfers of tokens between token holders on a block-by-block basis. It will be understood that either of these methods may be accomplished by instantiating a node on the BVM and downloading the blockchain for that BVM.

After determining the list of holder addresses of token holders with non-zero balances as of a date of record, the token contract audit system 145 may query the token contract registration system 140 to retrieve user information associated with the holder addresses. User information may include a preferred payment address as well as distribution eligibility criteria stored by the token contract registration system 140. Alternatively, in some embodiments, the preferred payment address for holder addresses is stored on the blockchain 112 of the token contract 110 and can be retrieved by the token contract audit system 145 directly.

User information may also include relevant flags for users, such as whether the user registration information has expired, whether the user account has been locked, or an ownership variable that indicates if the holder address is controlled by the issuing party or an individual otherwise affiliated with the issuing party. Alternatively, in some embodiments, the flags are stored as bits on the ledger 112 of the token contract 110.

After retrieving the additional user information, the token contract audit system 145 creates a list of holder addresses, potentially associated with preferred payment addresses, and potentially associated with additional information flags derived from the distribution eligibility criteria, and provides the list to the token distribution contract management system 150. In some embodiments, holder addresses that are associated with relevant flags that indicate the holder address should not receive a distribution are omitted from the list of holder addresses.

In some embodiments, the token distribution contract management system 150 communicates with the token registration system 140, which in turn generates an alert or other communication to inform users who are associated with relevant flags of issues with their user registration information. These issues may include, for example, a failure to provide a preferred payment address or the passing of an expiration date associated with the registration information of the user corresponding to the holder address. This communication is affected potentially through the use of an app alert, email, SMS message, or other form of communication known to those in the art. In some embodiments, a token holder's failure to resolve the flags via the token contract registration system 140 by a date provided by the token distribution contract management system 150 will inform the token distribution contract management system 150 to prohibit that user from withdrawing distribution tokens as described in the steps below.

Continuing with reference to FIG. 2 and system 100 of FIG. 1, at step 208, the token distribution contract management system 150 returns information to the issuing party regarding the blockchain ledger 112 of the token contract 110. In particular, in some embodiments, the token distribution contract management system 150 may inform the issuing party of the total number of tokens in circulation, the total number of tokens in circulation that are not held by certain parties or certain classes of parties, such as, for example, the issuing party or an individual otherwise affiliated with the issuing party, or the holder addresses or preferred payment addresses of token holders. The token distribution contract management system 150 may also report an intended amount of the total distribution payment for confirmation by the issuing party. Alternatively, at this step, the issuing party may inform the token distribution contract management system 150 of the total amount of the payment. In still other embodiments, the method skips this step, so as to allow step 206 to proceed directly to step 210.

Continuing with reference to FIG. 2 and system 100 of FIG. 1, at step 210, the token distribution contract management system 150 generates and publishes a token distribution contract 111 to the BVM. The token distribution contract 111 comprises one or more distribution contract wallets 113 for holding distinct distribution tokens to be paid to token holders. The token distribution contract 111 further comprises contract allowance instructions which, when run by the nodes of the BVM, manages withdrawal requests sent by registered users, or by a smart contract on their behalf, in order to transfer an allowance of funds, an amount of distribution tokens stipulated for each holder address of the registered user in the token distribution contract 111, from the one or more distribution contract wallets 113 to the holder addresses or preferred payment addresses. The one or more distribution contract wallets 113 can be at least two distribution contract wallets. Each of the at least two distribution contract wallets might provide storage for distinct distribution tokens.

If using the ERC-20 standard of the Ethereum Network, the token distribution contract management system 150 authorizes withdrawals by calling the approve( ) method. However, another similar protocol might be used. The token distribution contract management system 150, as part of generating and publishing the token distribution contract 111 to the BVM, calls the approve( ) method (or the equivalent thereof) for each holder address (which may be a registered user's preferred payment address) on the token holdings list received from the token contract audit system 145, thereby providing each holder address the rights to withdraw up to an allowance of funds, such as the amount of payment due in the form of distribution tokens, wherein the allowance of funds for each holder address is determined based on the non-zero token balance stored in the token distribution list for the holder address and, in some embodiments, the size of the distribution payment provided by the issuing party.

It should be understood that the token distribution contract management system 150 may calculate the allowance of funds according to the token distribution structure received from the issuing party, may receive instructions regarding the allowance of funds directly from the issuing party or another party or system. The token distribution contract 111 also comprises a bit flag indicating whether the contract 111 is available for distribution. The token distribution contract management system 150 initially sets this bit flag is initially set to “0,” thereby prohibiting all registered users from withdrawing funds from the distribution contract wallet 113. After generating and publishing the token distribution contract 111, the token distribution contract management system 150 informs the issuing party that the token distribution contract 111 is ready for deposits to fund the one or more distribution contract wallet 113.

Continuing with reference to FIG. 2 and system 100 of FIG. 1, at step 212, the issuing party funds the one or more distribution contract wallets 113 with the total payment amount. Funding the one or more distribution contract wallets 113 may comprise transferring a number of distribution tokens, including for example various stable coins, or Ether, to one or more distribution contract wallets 113. It should be understood that each distribution contract wallet 113 will preferably contain only one type of distribution token. Furthermore, in certain embodiments, in instances where the issuing party funds one or more distribution contract wallets 113 with a number of distribution tokens greater than sum of all allowances, the token distribution contract management system 150 permits the issuing party to withdraw the excess funds either before or after a specified date such as a date before or after users are able to withdraw from the one or more distribution contract wallets 113.

Continuing with reference to FIG. 2 and system 100 of FIG. 1, at step 214, after all of the one or more distribution contract wallets 113 have been funded, the distribution phase begins. In some embodiments, the issuing party may report the funding of the one or more distribution contract wallets 113 to the token distribution contract management system 150, and then the token distribution contract management system 150 may confirm that the one or more distribution contract wallets 113 have been fully funded to a predetermined amount of distribution tokens. Alternatively, the token distribution contract management system 150 may periodically or continuously poll the blockchain system 105 to determine when the issuing party has fully funded all of the one or more distribution contract wallets 113. Alternatively, the token distribution contract management system 150 may periodically or continuously review the blockchain system 105 event log to determine when the issuing party has fully funded the one or more distribution contract wallets 113 Alternatively, the issuing party may instruct the token distribution contract management system 150 that the one or more distribution contract wallets 113 have been fully funded without the token distribution contract management system 150 subsequently verifying the status of the one or more distribution contract wallets 113.

After determining that the one or more distribution contract wallets 113 have been fully funded or being informed as such, the token distribution contract management system 150 calls a method on the BVM to set the bit flag allowing distribution to “1,” indicating that distribution phase has begun and that distribution is now available. In some embodiments, once the distribution phase has begun, the token distribution contract management system 150 prevents the addition of further funds from the issuing party to the one or more distribution contract wallets 113 by use of a similar bit flag.

After beginning the distribution phase, users have the capability to withdraw the funds associated with their holder addresses to their preferred payment addresses from the token distribution contract wallets 113. This withdrawal may be accomplished by the use of the transferFrom( ) method, if using the ERC-20 standard of the Ethereum Network, or other similar method on another BVM. If the request for distribution by a registered user is for a holder address that is not assigned an allowance of funds, or is larger than the allowance of funds stipulated for the holder address on the distribution contract 111, then the token distribution contract management system 150 rejects the withdrawal request. The token distribution contract management system 150 optionally communicates with the token registration system, which in turn generates an alert or other communication to inform users of their ability to withdraw funds, potentially through the use of an app alert, email, SMS message, or other form of communication known to those in the art.

In another embodiment, for an ERC20-compliant token contract running on a BVM, during the distribution phase of the distribution process, registered users may use the allowance( ) method to view the amount of distribution coins remaining on the distribution contract 111 for any of their holder addresses, by supplying the address of distribution contract 111—as the first argument and the holder address for which they wish to check their remaining balance as the second argument.

Additionally, as part of step 214, in some embodiments when all registered users have withdrawn their assigned distribution tokens or after the expiration of a specific date as determined by the distribution contract 111 or provided by the issuing party via the token distribution contract management system 150, the token distribution contract management system 150 terminates the distribution contract 111, thereby preventing any future blockchain transactions with one or more distribution contract wallets 113.

The above method may be repeated in sequence for any given desired series of distributions by the issuing party or by the defined rule set of the token contract 110. Similarly, any number of instances of the above method may be performed in parallel for distinct distribution payments by an issuing party.

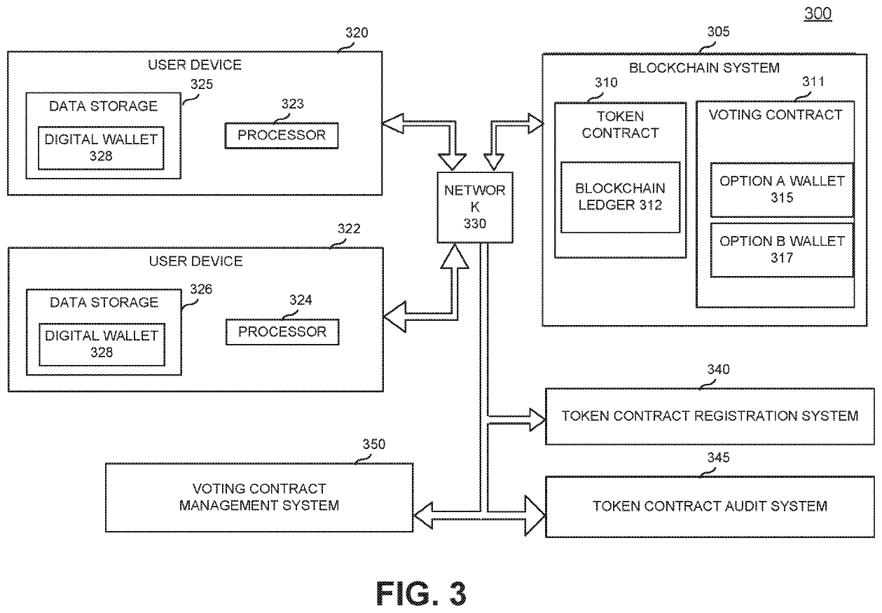

FIG. 3 shows a block diagram of a system 300 for efficient blockchain-based voting for voting events as determined by the token holdings on a token contract. The system 300 includes a blockchain system 305, which may be a BVM, implementing a token contract 310 that includes a blockchain ledger 312, a plurality of user computing devices 320 and 322, a token contract registration system 340 that interacts with each of the plurality of user computing devices 320 and 322 and the blockchain system 305 via a network 330 (e.g., the Internet or an intranet), a token contract audit system 345 that interacts with the token contract 310 via a network 330, a voting contract management system 350, which interacts with the token contract 310, token contract registration system 340, and token contract audit system 345. The voting contract management system 350 generates, publishes, and administers a voting contract 311 that, in some embodiments, includes a first option address (Option A address) 315, and a second option address (Option B address) 317 and runs on the blockchain system 305. The voting contract 311 may be a data structure that encodes for rules, requirements and constraints of the voting contract. Those rules may include the nature of the voting, such as that each vote can be cast once and, if cast, is a vote for a first ballot option (Option A) or a second ballot option (Option B). A vote for a ballot option might be effected by as a blockchain transaction from a voter's address to an address associated with a ballot option. These addresses are encoded in, or included with, the voting contract. An example is voting contract 311 that refers to two option addresses 315, 317.

In various embodiments, the voting contract 311 can include any number of option addresses. It will be appreciated that, in various embodiments, the token contract registration system 340, the token contract audit system 345, and the voting contract management system 350 communicate in various combinations with each other, with the user devices 320 and 322, and with the blockchain system 305 with its contracts and components via a network 330. The user computing devices 320 and 322 can interact with the voting contract 311 via the network 330 in certain embodiments.

Each of the plurality of user computing devices includes respective hardware processors 323 and 324 operatively connected to electronic data storage 325 and 326, such as volatile or non-volatile memory. In the illustrated example, the electronic data storage 325 and 326 at each of the plurality of user computing devices 320 and 322 stores a digital wallet 327 and 328. A digital wallet 327 and 328 can be a data structure used to store associated data on common or dedicated electronic data storage (e.g., RAM, or a hard-drive). In certain examples, dedicated hardware devices, such as a hardware security module (HSM), may be used to store information associated with the digital wallets 327 and 328. In certain example embodiments, the digital wallet 327 and 328 may be stored on a dedicated storage hardware that is implemented externally and in communication with the system 300 for at least a time necessary to complete a transaction (e.g., via a communication link or local bus connection).

Each digital wallet 327 and 328 can be implemented as software instructions executed by a hardware processor, or specifically designed hardware, that stores information that allows an individual to make electronic commerce transactions that use, for example, a blockchain. Each digital wallet 327 and 328 can include or store a data structure that holds a private key and one or more BVM addresses that are a product of the private key. Other users can utilize these identifiers to send blockchain transactions to the BVM associated with a stored address, which can then be used to perform authorized actions on the blockchain. In some systems, authority for such transactions can be conveyed by signing messages with a digital signature generated from the private key corresponding to the appropriate holder address. In certain exemplary embodiments, each digital wallet 327 and 328 may only be capable of sending blockchain transactions to the BVM with a stored address after users provide a private key or other identifier by direct manual input, for example, from a keyboard, by spoken instructions, or using a device that identifies a specific biometric marker.

Multiple computer nodes implement the token contract 310, and each node operates to validate blockchain transactions submitted to the token contract. Generally, only one of the nodes needs to receive a blockchain transaction that an address on the blockchain system 305, whether the address is an external address or a smart contract running on the BVM and controlled by an external address, has submitted for the blockchain transaction process to continue. Once an instance of the token contract 310 at one node receives a blockchain transaction, it may propagate the blockchain transaction to other nodes within the blockchain system 305. Each node that is part of the blockchain system 305 may also keep a copy or a portion of the blockchain in memory that is local to the corresponding node.

As shown in FIG. 3, embodiments of the systems and methods provided herein provide tools for registration, such as a token contract registration system 340, to collect relevant registration information from registered users, who may be current token holders of security tokens as determined by the token contract 310 or are interested in purchasing or acquiring security tokens. Registration information could include, but is not limited to, a name, physical address, contact information, country of citizenship and country of residence for individuals, and countries where the registering user meets requirements for being accredited or qualified. Registered users may also be organization, in which case the registration information could include, but is not limited to, name of organization, company address, contact information, name of signatory authority, country of organization or incorporation, country/countries of business operation, and the status of certain business licenses if applicable. Registration information may also include registration of a preferred voting address, which is a holder address that a registered user indicates as the desired blockchain identity with which a user will cast his or her votes (such as when the user indicates that he or she will submit all “voting blockchain transactions” to the blockchain system using the private key associated with the preferred voting address). Voting blockchain transactions can include, but are not limited to, calling voting method function calls of the voting contract 311, as well as any transfer function involving voting tokens as according to various embodiments.

In some embodiments, a registered user may have more than one associated holder address as part of his or her registration information. In many embodiments, a user may have more than one associated holder address but only one holder address identified as a preferred voting address. The issuing party or the token contract registration system 340 can collect registration information for a given token holder, as necessary, before the initiation of any distribution. In some embodiments, the token contract registration system 340 reviews the registration information to in order to verify its authenticity, such as whether a provided mailing address is a legitimate address, or that passes various KYC/AML, verification requirements. When the token contract registration system 340 finds the registration information for a given user to be verified, it stores that registration information indexed to that user's one or more holder addresses herein referred to as a “validated holder address.” In other embodiments, another party, such as human agents, perform all or a part of the verification process and report their determination to the token contract registration system 340.

In one embodiment, the token contract registration system 340 preferred voting address for a registered user may be stored by the token contract registration system 340 on the token contract 310 with each corresponding validated holder address associated with the registered user. In another embodiment, the token contract registration system 340 instead transmits the preferred voting address to the voting contract management system 350 for storage on a newly generated voting contract 311.

In another embodiment, the registered user is allowed to update their preferred voting address after the date of record, but before the initiation of voting, and the change in their preferred voting address is communicated to the voting contract management system 350 for incorporation into the additionally generated voting contract 311. In another embodiment, additional voting eligibility criteria for each validated holder address of a registered user, wherein the voting eligibility criteria are determined according to a defined rule set governing voting from the token contract 310 for a voting event, are also stored on the token contract 310 by the registration system 340. The additional eligibility criteria can include, for example, an expiration date for the user's registration information, a lock status variable that can be used to indicate that a registered user is prohibited from voting (or from receiving voting tokens in certain embodiments), or a variable that indicates if the validated holder address is owned by the issuer of the token or an individual otherwise affiliated with the issuer of the token.

As shown in FIG. 3, embodiments of the systems and methods provided herein provide tools also for auditing of the token contract 310, such as a token contract audit system 345, to conduct an audit of the token contract as of a specified date, typically a date of record, by monitoring or examining from the ledger 312 of token holdings on the token contract 310. In monitoring or examining the ledger 312 of the token contract 310 in its entirety, the token contract audit system 345 produces a digital token holdings list of all validated holder addresses with non-zero token balances as of the date of record.

In one embodiment, if the preferred voting address for a registered user who owns or controls a validated holder address is also stored on the token contract 310 along with the validated holder address and the token balance, then the token contract audit system 345 can also embed the preferred voting address for each validated holder address with non-zero balance into the generated token holdings list that the token contract audit system 345 sends to the voting contract management system 350. This allows users in possession of multiple validated holder addresses that each hold a separate quantity of security tokens on the token contract 310 to vote with a single preferred voting address. For example, if one person or legal entity registers with the token contract registration system 340 as one entity but owns or controls several holder addresses that are allowed votes, the voting contract might logically aggregate those holder addresses to one preferred voting address so the person or entity only need vote with one address, their preferred voting address.

In one embodiment, the token contract audit system 345 will review the token contract 310 by reviewing blocks on the blockchain from the inception date of the token contract 310 up until the last block added to the blockchain ledger 312 with a timestamp before the date of record. In another embodiment, the token contract audit system 345 also considers additional eligibility criteria for a registered user stored on the token contract 310 to determine if the registered user's holder addresses and balances should be placed into the digital token holdings list.

In one example, if the expiration date of registration information for the registered user has expired, then the token contract audit system 345 does not write the validated holder address and associated token balance into the digital token holdings list. In another example, if the expiration date of registration information for the registered user has expired, then the token contract audit system 345 writes the validated holder address and associated token balance into the digital token holdings list but with an attendant Boolean flag reflecting expiration. In another example, if the lock status variable is set to true, indicating that the validated holder address is locked and unable to participate in blockchain transactions, then the token contract audit system 345 does not write the validated holder address and associated token balance into the digital token holdings list.

In yet another embodiment, if the lock status variable is set to true, indicating that the validated holder address is locked and unable to participate in blockchain transactions, then the token contract audit system 345 writes the validated holder address and associated token balance into the digital token holdings list but with an attendant Boolean flag reflecting that the registered user's holder address is locked. In another example, if the validated holder address is owned by the issuer of the token or an individual otherwise affiliated with the issuer of the token, then the token contract audit system 345 does not write such a validated holder address and associated token balance into the digital token holdings list. In yet another embodiment, if the validated holder address is owned by the issuer of the token or an individual otherwise affiliated with the issuer of the token, then the token contract audit system 345 writes such a validated holder address and associated token balance into the digital token holdings list, but with an attendant set of bits reflecting that the registered user's holder address is controlled by the issuing company or by an individual otherwise affiliated with the issuer of the token.

As shown in FIG. 3, embodiments of the systems and methods provided herein also provide tools for a voting contract management system 350 that generates, publishes, and administers an additional smart contract, referred to as a voting contract 311, which is made available on the blockchain system 305 for token holders who are eligible to receive an allocation of votes for a voting event as determined by their possession of security tokens. Criteria used to determine eligibility might comprise user status, user constraints, tax domicile, citizenship, residency, or other user detail on the date of record. In many embodiments, a new voting contract 311 is created after the date of record based on the contents of the distribution token holding list of produced by the token contract audit system 345.

In some embodiments, the voting contract 311 comprises program code defining vote details and vote weight for all or some preferred voting addresses. Vote details can include, but are not limited to, ballot options, method calls for voting for specific ballot options, and a timeframe in which voting blockchain transactions are permitted. A vote weight is a numerical value assigned to each preferred voting address as determined by the token holdings list.

When a user calls a voting method as part of a transaction submitted to the blockchain system 305 and signed with a digital signature associated with the user's preferred voting address, the voting contract 311 allocates at least a portion of the user's vote weight to a specific ballot option's score (the sum of all vote weights applied to a specific ballot option). In some embodiments, the voting contract 311 only allows a user to apply all of his or her vote weight to a single ballot option. In other embodiments, a user can allocate his or her total vote weight among a plurality of ballot options. In a typical embodiment, a user can not apply a total vote weight to one or more ballot options that exceeds the user's original vote weight as defined in the vote details. In some embodiments, all users' voting weights are set to “1,” allowing for an equality of voting power among all token holders regardless of the quantity of security tokens they hold. In a typical embodiment, voting blockchain transactions submitted after the close of the timeframe as defined by the voting contract 311 are automatically rejected, and any remaining unallocated vote weights remain unallocated to any ballot option.

In a typical embodiment, the voting contract 311 further comprises program code for automatically executing additional machine instructions as a result of one ballot option having a greatest ballot option score at the close of the timeframe. For example, the voting contract system 311 can include program code for communicating to a voting contract management system 350 on the blockchain system if a first ballot option (e.g., ballot option A) has the highest ballot option score at the close of the timeframe.

In some embodiments, the voting contract 311 contains program code for one or more option addresses (e.g., Option A address 315 and Option B address 317) with a corresponding address that is administered by the voting contract management system 350. As determined by the token holdings list, the voting contract management system 350 assigns an allotment of voting tokens to each user's preferred voting address, and users can claim their allotments of voting tokens from the voting contract 311 to another address under their control by calling a claim function that is signed by a digital signature associated with their preferred voting address. Within a certain timeframe defined on the voting contract 311 by the voting contract management system 350, users can then transfer their voting tokens into the one or more option addresses (e.g., Option A address 315 and Option B address 317) according to each user's choosing. In another embodiment, users need not claim voting tokens into their separate holder addresses before voting. In that embodiment, the voting contract management system 350 publishes the voting contract 311 that includes program code defining each user's allotment as defined by the token holdings list. Users can then call a transfer function to move up to their allotment of voting tokens from the voting contract 311 to the option addresses (e.g., Option A address 315 and Option B address 317). In some embodiments, users must move their entire allotment of voting tokens into a single option address. In other embodiments, users can distribute their voting tokens in any ratio among any number of option address. In a typical embodiment, blockchain transactions that transfer voting tokens that are submitted after the close of the timeframe as defined by the voting contract 311 are automatically rejected, and any remaining vote tokens not transferred into an option address (or remain in the voting contract 311) remain unallocated to any option address (e.g., Option A address 315 and Option B address 317.)

In a typical embodiment, the voting contract 311 further comprises program code for automatically executing additional machine instructions as a result of one option address (e.g., Option A address 315 and Option B address 317) having a greatest total of voting tokens at the close of the timeframe. For example, the voting contract 311 can include program code for communicating to a distribution contract on the blockchain system to unlock an associated distribution contract, thereby making its stored tokens available for users to claim, if Option A address 315 contains a greatest sum of voting tokens at the close of the timeframe. The voting contract 311 might also specify an action to take in case of ties.

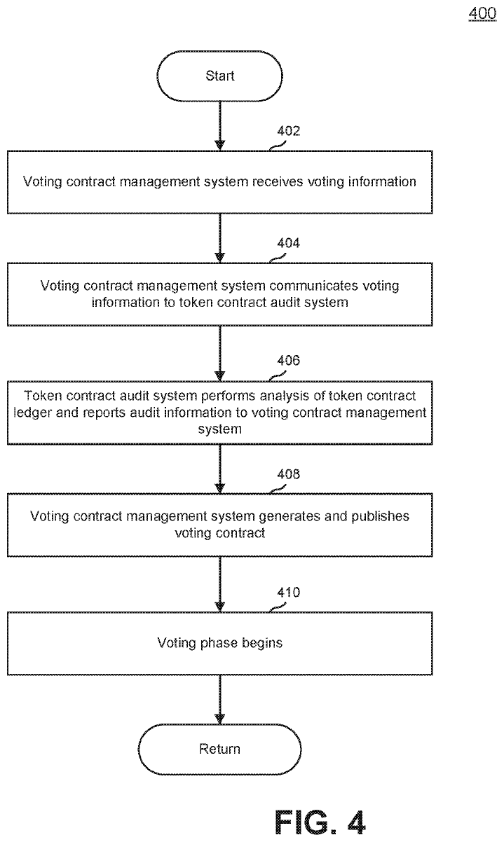

In view of the foregoing structural and functional features described above, example methods will be better appreciated with reference to FIG. 4. While, for purposes of simplicity of explanation, the example methods of FIG. 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The methods can be implemented by the system 300 of FIG. 3 in certain embodiments.

FIG. 4 describes a method of administrating a voting event for token holders. At step 402 therein, a voting contract management system, such as the voting contract management system of FIG. 3, receives voting information. A voting contract management system may receive the voting information from the issuer or some other authority that has obligations to token holders to run a voting event, or otherwise elects to do so. The issuing party may do so through the use of an API, although the invention is not so limited. The voting information includes, for example, the date of record from which the voting allocations are to be determined, and the day or dates on which voting is to be allowed to occur. These details may also include, for example, the structure of the distribution of voting allocations (e.g., voting tokens and/or vote weight allocations) according to a defined rule set governing voting allocations for the token contract, such as the amount or percentage of the voting tokens/vote weight that each token holder is entitled to receive, and the total amount of the voting tokens/vote weight from which the voting allocations shall be calculated as according to various embodiments. For example, the issuing party may inform the voting contract management system that each token holder is entitled to a fixed and equal number of vote allocations. In another example, the issuing party may inform the voting contract management system that each token holder is entitled to a vote allocation in accordance to a predetermined ratio of their security token holdings compared to all security tokens held by all token holders.

At step 404, the voting contract management system initiates a token contract audit by informing the token contract audit system of at least a portion of the voting information. In some embodiments, the voting contract management system informs the token contract audit system of the date of record. In other embodiments, the voting contract management system further informs the token contract audit system of other information relevant to the audit, such as any offsets in the date of record for certain types of token holders or token blockchain transactions.

At step 406, the token contract audit system performs an analysis of the token contract ledger so as to generate a token holdings list comprising voting distribution data wherein the voting distribution data includes holder addresses as of the date of record who are to receive voting allocations, the amount of tokens held by each of the token holders' holder addresses on the token contract, and if applicable the preferred voting address of each token holder. In one embodiment, the token contract audit system only stores voting distribution data on the token holdings list for a holder address, if the corresponding balance of tokens on the token contract was non-zero for the holder address as of the date of record. In one embodiment, the token contract audit system stores the token holding list as a key/value mapping between the holder address and the other distribution data, although other data structures are possible. In another embodiment, the token contract audit system stores the token holding list as a key/value mapping as part of an additional audit token contract, published by the voting contract management system on the blockchain system. In other embodiments, the token contract audit system stores the token holding list outside of the blockchain in a database for later querying by the voting contract management system. The date of record could be a date and time in the past, wherein the token contract and system can analyze the token contract ledger, identify blockchain transactions that occurred only before that date and time, and use those to determine which holder addresses were in control of which tokens, and thus were token holders, at that date and time. The voting contract might be encoded with rules regarding how to deal with ambiguous cases, if any.

It will be appreciated that in certain BVMs, determining the balances of token holders as of a prior date may not be possible simply by calling a method of the token contract or examining the current state of the token contract. In some embodiments, the token contract audit system may instead re-create the token contract ledger as of a record date by examining the blockchain ledger block-by-block, starting from the first block at the inception of the token contract, tracking both the initial balances of newly registered holder addresses and any transfers of tokens between the holder addresses, and maintaining a temporary state of token holdings that is updated with each tracked blockchain transaction. This examination halts with the final block that was written to the blockchain with a timestamp closest to and before the date/time of record, although examination may continue to account for offsets in the date/time of record for certain types of token holders or token blockchain transactions. In one embodiment, once the token contract audit system completes the examination, the token contract audit system records the latest state of token holdings representing token ownership as of the date of record across all holder addresses on the token contract. The token contract audit system then evaluates this latest state of token holdings in order to populate the token holdings list with the relevant distribution data. Alternatively, the token contract audit system may read the event log of the blockchain system, if one exists, to track the transfers of tokens between token holders on a block-by-block basis. It will be understood that either of these methods or similar methods may be accomplished by instantiating a node on the BVM and downloading the blockchain for that BVM.

After determining the list of holder addresses with non-zero balances as of a date of record, the token contract audit system may query the token contract registration system to retrieve user information associated with the holder addresses. User information may include a preferred voting address as well as voting eligibility criteria stored by the token contract registration system, perhaps in an off-blockchain database. Alternatively, in some embodiments, the preferred voting address for registered holder addresses is stored on the blockchain of the token contract and can be retrieved by the token contract audit system directly.

User information may also include relevant flags for users, such as whether the user registration information has expired, whether the user account has been locked, or an ownership variable that indicates if the holder address is controlled by the issuing party or an individual otherwise affiliated with the issuing party. Alternatively, in some embodiments, the flags are stored as bits on the ledger of the token contract.

After retrieving the additional user information, the token contract audit system creates a list of holder addresses, potentially associated with preferred voting addresses, and potentially associated with additional information flags derived from the voting eligibility criteria, and provides the list to the voting contract management system. In some embodiments, holder addresses that are associated with relevant flags that indicate the holder address should not be able to vote and are omitted from the list of holder addresses. For example, if a token holder does not have a necessary registered user information.

In some embodiments, the voting contract management system communicates with the token registration system, which in turn generates an alert or other communication to inform users who are associated with relevant flags of issues with their user registration information. These issues may include, for example, a failure to provide a preferred voting address or the passing of an expiration date associated with the registration information of the holder address. This communication is affected potentially through the use of an app alert, email, SMS message, or other form of communication known to those in the art. In some embodiments, a token holder's failure to resolve the flags via the token contract registration system by a date provided by the voting contract management system will inform the voting contract management system to prohibit that user from voting in the steps described below. At the end of step 406, the token holdings list is then communicated to the voting contract management system.

At step 408, the voting contract management system generates program code defining the voting contract as determined by the tokens holding list and voting information and publishes the voting contract to the blockchain system by submitting a blockchain transaction that comprises the program code for the voting contract. In many embodiments, the program code comprises vote allocations (e.g., vote weights or voting token distributions) for each preferred voting address. In further embodiments, the program code allows for the creation of a voting contract and one or more option addresses as well as function calls to transfer voting tokens into or out of addresses stored on the voting contract. In additional embodiments, the program code defines methods for user to allocate their vote weights to ballot options in blockchain transactions signed with their preferred voting address. In still further embodiments, the program code defines a timeframe in which users are allowed to vote. In many embodiments, the program code includes additional machine instructions for additional operations on the blockchain system as a result of one ballot option or option address having a greatest value at the close of the timeframe. The above described voting parameters (e.g., allocations, timeframe, function calls, etc.) can be collectively considered “voting instructions” encoded in the program code of the voting contract in some embodiments. In some embodiments, the voting contract management system might notify an issuing party or another party, such as a regulatory party, of certain details of the voting contract (e.g., total voting allocations, timeframe, etc.) for review and approval before submission of the voting contract's program code to the blockchain system.

At step 410, the voting phase begins. In certain embodiments, users can call voting method functions on the voting contract by submitting blockchain transactions, signed with their preferred voting address, that apply their vote weights to ballot options. In other embodiments, users can claim voting tokens from the voting contract into option addresses or into their own address to subsequently transfer into option addresses at a future time. In other embodiments, users can transfer voting tokens from the voting contract directly into option addresses by submitting blockchain transactions signed with their preferred voting address. Claiming a voting token might take the form of a voter, using function calls to a contract or otherwise, causing the creation and submission of a blockchain transaction that signals that the voting token is removed from the voting contract (so it cannot later be removed again and double voted) and is placed into the voter's address. The voting token would then be recognized on the blockchain as being under the control of the person or entity that controls the address. A subsequent blockchain transaction, initiated by the voter, can show a voting event, e.g., a blockchain transaction transferring the voting token from the voter's address to a ballot option's address.

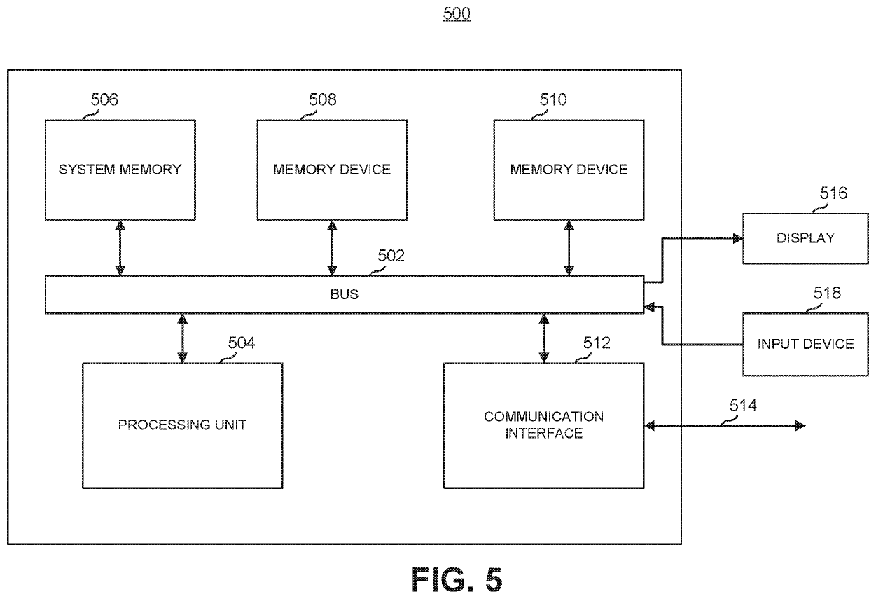

FIG. 5 illustrates an example computer system 500 that can be employed to implement examples of the systems and methods disclosed in FIGS. 1-4. The computer system 500 can be implemented on one or more general purpose networked computer systems, embedded computer systems, routers, switches, server devices, client devices, various intermediate devices/nodes and/or stand-alone computer systems. It will be appreciated that, given the distributed nature of the blockchain system, the illustrated computer system 500 can be one of a plurality of computer systems that execute nodes of the blockchain system. Alternatively, the illustrated computer system can represent a user device storing a digital wallet or the token distribution contract management system 150 of FIG. 1.

The system 500 can include a system bus 502, a processing unit 504, a system memory 506, memory devices 508 and 510, a communication interface 512 (e.g., a network interface), a communication link 514, a display 516 (e.g., a video screen), and an input device 518 (e.g., a keyboard and/or a mouse). The system bus 502 can be in communication with the processing unit 504 and the system memory 506. The additional memory devices 508 and 510, such as a hard disk drive, server, stand-alone database, or other non-volatile memory, can also be in communication with the system bus 502. The system bus 502 interconnects the processing unit 504, the memory devices 506-510, the communication interface 512, the display 516, and the input device 518. In some examples, the system bus 502 also interconnects an additional port (not shown), such as a universal serial bus (USB) port.

The processing unit 504 can be a computing device and can include an application-specific integrated circuit (ASIC). The processing unit 504 executes a set of instructions to implement the operations of examples disclosed herein. The processing unit can include a processing core.

The additional memory devices 506, 508 and 510 can store data, programs, instructions, database queries in text or compiled form, and any other information that can be needed to operate a computer. The memories 506, 508 and 510 can be implemented as computer-readable media (integrated or removable) such as a memory card, disk drive, compact disk (CD), or server accessible over a network. In certain examples, the memories 506, 508 and 510 can comprise text, images, video, and/or audio, portions of which can be available in formats comprehensible to human beings. Additionally, or alternatively, the system 500 can access an external data source or query source through the communication interface 512, which can communicate with the system bus 502 and the communication link 514.

In operation, the system 500 can be used to implement one or more parts of a system for trading security tokens in accordance with an embodiment. Computer executable logic for implementing various components of the system reside on one or more of the system memory 506, and the memory devices 508, 510 in accordance with certain examples. The processing unit 504 executes one or more computer executable instructions originating from the system memory 506 and the memory devices 508 and 510. The term “computer readable medium” as used herein refers to any medium that participates in providing instructions to the processing unit 504 for execution, and it will be appreciated that a computer readable medium can include multiple computer readable media each operatively connected to the processing unit.

Embodiments of the disclosure can be described in view of the following clauses:

1. A computer-implemented system for efficient distribution of digital assets according to a token contract in accordance with a rule set governing token ownership, transactions, and entitlements, comprising:
a token contract audit system, coupled to a blockchain ledger of a blockchain system, associated with the token contract, that examines the blockchain ledger to generate a token holdings list that comprises holder addresses and corresponding token balances as of a provided date of record or other predetermined point in time; and
a token distribution contract management system that communicates with the token contract audit system and generates, publishes, and administers a distribution contract using a blockchain virtual machine of the blockchain system, that comprises at least one distribution contract and contract allowance instructions,
wherein the token distribution contract management system generates the contract allowance instructions according to the token holdings list received from the token contract audit system, and
wherein the token distribution contract management system allows users to communicate with the distribution contract to receive one or more distribution of digital assets according to the contract allowance instructions.
2. The computer-implemented system of clause 1, further comprising a token contract registration system that is configured to receive and store user registration information from users in association with holder addresses.
3. The computer-implemented system of clause 2, wherein the token contract audit system is configured to communicate with the token contract registration system to retrieve additional distribution eligibility criteria associated with holder addresses for inclusion on the token holdings list.
4. The computer-implemented system of clause 2 or 3, wherein the token contract audit system is configured to communicate with the token contract registration system to retrieve additional distribution eligibility criteria associated with holder addresses, and wherein the additional distribution eligibility criteria instruct the token contract audit system to exclude associated holder addresses from the token holdings list.
5. The computer-implemented system of any of clauses 1-4, wherein the distribution contract comprises at least one distribution contract wallet and wherein each distribution contract wallet comprises storage for a distinct distribution token.
6. The computer-implemented system of any of clauses 1-5, wherein the contract allowance instructions enable users on the token holdings list to communicate with the distribution contract using a validated holder address.
7. The computer-implemented system of clause 6, wherein the contract allowance instructions enable users on the token holdings list to communicate with the distribution contract using a preferred payment address.
8. A computer-implemented system for coordinating voting according to a rule set that governs a token contract implemented on a distributed computing system:
a token contract audit system, coupled to a blockchain ledger of a blockchain system, associated with the token contract, that examines the blockchain ledger to generate a token holdings list that comprises holder addresses and corresponding token balances as of a provided date of record or other predetermined point in time; and
a voting contract management system that communicates with the token contract audit system and generates, publishes, and administers a voting contract using a blockchain virtual machine of the blockchain system, that comprises voting instructions and contract allowance instructions,
wherein the voting contract management system generates the voting instructions according to the token holdings list received from the token contract audit system, and wherein the voting contract management system allows users to communicate with the voting contract to vote according to the voting instructions.
9. The computer-implemented system of clause 8, further comprising a token contract registration system that is configured to receive and store user registration information from users in association with holder addresses.
10. The computer-implemented system of clause 9, wherein the token contract audit system is configured to communicate with the token contract registration system to retrieve additional voting eligibility criteria associated with holder addresses for inclusion on the token holdings list.
11. The computer-implemented system of clause 9 or 10, wherein the token contract audit system is configured to communicate with the token contract registration system to retrieve additional voting eligibility criteria associated with holder addresses, and wherein the additional voting eligibility criteria instruct the token contract audit system to exclude associated holder addresses from the token holdings list.
12. The computer-implemented system of any of clauses 8-11, wherein the voting contract comprises at least two option addresses and wherein each of the at least two option addresses comprises storage for a distinct voting token.
13. The computer-implemented system of any of clauses 8-12, wherein the voting instructions enable users on the token holdings list to communicate with the voting contract using a validated holder address.
14. The computer-implemented system of 13, wherein the voting instructions enable users on the token holdings list to communicate with the voting contract by sending voting tokens to an option address.
15. The computer-implemented system of clause 14, wherein the token holders receive voting tokens based on their security token holdings and the voting tokens are distributed between the option addresses.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented system for efficient distribution of digital assets according to a token contract in accordance with a rule set governing token ownership, transactions, and entitlements, comprising:
a token contract audit system, coupled to a blockchain ledger of a blockchain system, associated with the token contract, that examines the blockchain ledger to generate a token holdings list that comprises holder addresses and corresponding token balances as of a provided date of record or other predetermined point in time; and
a token distribution contract management system that communicates with the token contract audit system and generates, publishes, and administers a distribution contract using a blockchain virtual machine of the blockchain system, that comprises at least one distribution contract and contract allowance instructions,
wherein the token distribution contract management system generates the contract allowance instructions according to the token holdings list received from the token contract audit system, and
wherein the token distribution contract management system allows users to communicate with the distribution contract to receive one or more distribution of digital assets according to the contract allowance instructions.

2. The computer-implemented system of claim 1, further comprising a token contract registration system that is configured to receive and store user registration information from users in association with holder addresses.

3. The computer-implemented system of claim 2, wherein the token contract audit system is configured to communicate with the token contract registration system to retrieve additional distribution eligibility criteria associated with holder addresses for inclusion on the token holdings list.

4. The computer-implemented system of claim 2, wherein the token contract audit system is configured to communicate with the token contract registration system to retrieve additional distribution eligibility criteria associated with holder addresses, and wherein the additional distribution eligibility criteria instruct the token contract audit system to exclude associated holder addresses from the token holdings list.

5. The computer-implemented system of claim 1, wherein the distribution contract comprises at least one distribution contract wallet and wherein each distribution contract wallet comprises storage for a distinct distribution token.

6. The computer-implemented system of claim 1, wherein the contract allowance instructions enable users on the token holdings list to communicate with the distribution contract using a validated holder address.

7. The computer-implemented system of claim 6, wherein the contract allowance instructions enable users on the token holdings list to communicate with the distribution contract using a preferred payment address.

8. A computer-implemented system for coordinating voting according to a rule set that governs a token contract implemented on a distributed computing system:
a token contract audit system, coupled to a blockchain ledger of a blockchain system, associated with the token contract, that examines the blockchain ledger to generate a token holdings list that comprises holder addresses and corresponding token balances as of a provided date of record or other predetermined point in time; and
a voting contract management system that communicates with the token contract audit system and generates, publishes, and administers a voting contract using a blockchain virtual machine of the blockchain system, that comprises voting instructions and contract allowance instructions,
wherein the voting contract management system generates the voting instructions according to the token holdings list received from the token contract audit system, and
wherein the voting contract management system allows users to communicate with the voting contract to vote according to the voting instructions.

9. The computer-implemented system of claim 8, further comprising a token contract registration system that is configured to receive and store user registration information from users in association with holder addresses.

10. The computer-implemented system of claim 9, wherein the token contract audit system is configured to communicate with the token contract registration system to retrieve additional voting eligibility criteria associated with holder addresses for inclusion on the token holdings list.

11. The computer-implemented system of claim 9, wherein the token contract audit system is configured to communicate with the token contract registration system to retrieve additional voting eligibility criteria associated with holder addresses, and wherein the additional voting eligibility criteria instruct the token contract audit system to exclude associated holder addresses from the token holdings list.

12. The computer-implemented system of claim 8, wherein the voting contract comprises at least two option addresses and wherein each of the at least two option addresses comprises storage for a distinct voting token.

13. The computer-implemented system of claim 8, wherein the voting instructions enable users on the token holdings list to communicate with the voting contract using a validated holder address.

14. The computer-implemented system of claim 13, wherein the voting instructions enable users on the token holdings list to communicate with the voting contract by sending voting tokens to an option address.

15. The computer-implemented system of claim 14, wherein the token holders receive voting tokens based on their security token holdings and the voting tokens are distributed between the option addresses.
